(19) United States
(12) Patent Application Publication
(10) Pub. No.: US 2024/0002633 A1
(43) Pub. Date: Jan. 4, 2024

(54) FUNCTIONALIZED DENDRITIC NANOPARTICLES IN THERMOSET MATERIALS

(71) Applicant: SAUDI ARABIAN OIL COMPANY, Dhahran (SA)

(72) Inventors: Aziz Fihri, Paris (FR); Yassine Malajati, Beachwood, OH (US); Abdullatif Jazzar, Khobar (SA); Remi Mahfouz, Dhahran (SA)

(73) Assignee: SAUDI ARABIAN OIL COMPANY, Dhahran (SA)

(21) Appl. No.: 17/855,403

(22) Filed: Jun. 30, 2022

(51) Int. Cl. C08K 3/36; C08G 59/50

(52) U.S. Cl. CPC C08K 3/36; C08G 59/5006; C08K 2201/011

(57) ABSTRACT

A functionalized inorganic filler includes a dendritic fibrous nanoparticle that has a surface functionality including at least one amine functional group linked to a surface of the dendritic fibrous nanoparticle. A method of making a functionalized inorganic filler includes reacting an inorganic particle precursor and a shape-directing agent to provide a dendritic fibrous nanoparticle, then reacting the dendritic fibrous nanoparticle with a reactive compound that has at least one amine functional group to form the functionalized inorganic filler. A polymer composite includes an epoxy-based polymer matrix and a functionalized inorganic filler.

### BACKGROUND

Epoxy resins are an important class of thermosetting polymers, containing more than one epoxy group capable of reacting with suitable curing agents to form highly crosslinked/three-dimensional networks after curing. Other constituents such as catalysts, fillers, or diluents may be included in the formulation to modify certain properties of the thermoset material. Because of their unique structures, epoxies exhibit superior properties including high mechanical strength, high adhesive strength, low shrinkage, good chemical resistance, and good electrical insulation properties, among others. These properties enable epoxy resins to have a widespread use in different applications such as coatings, adhesives, composites, etc., and for different sectors including building and construction, automotive, aerospace, electronics, renewable energy (e.g. wind turbines, rotor blades, etc.).

However, the highly crosslinked nature of epoxies causes them to be relatively brittle and stiff, with poor resistance to crack initiation and growth and hence low hardness and impact resistance. This inherent brittleness and low hardness are indeed some of the major drawbacks of epoxy resins limiting their use in a number of applications, particularly structural applications. In epoxy-based composites such as carbon fiber- or glass fiber reinforced plastics (CFRP and GFRP), minor impacts, especially transverse impacts, can result in very small defects and damages known as barely visible damages (BVD), that may lead to debonding and delamination issues. If not properly addressed, these issues can cause serious safety concerns and may lead to dramatic failures, especially in safety-sensitive industries such as aeronautics, defense, oil and gas, etc. Accordingly, there exists a need for the development of epoxy-based resins that exhibit increased hardness and impact resistance while maintaining their other superior properties.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a functionalized inorganic filler including a dendritic fibrous nanoparticle that has a surface functionality including at least one amine functional group linked to a surface of the dendritic fibrous nanoparticle.

In another aspect, embodiments disclosed herein relate to a method of making a functionalized inorganic filler. The method includes reacting an inorganic particle precursor and a shape-directing agent to provide a dendritic fibrous nanoparticle. Then the dendritic fibrous nanoparticle is reacted with a reactive compound that has at least one amine functional group to form the functionalized inorganic filler.

In yet another aspect, embodiments disclosed herein relate to a polymer composite including an epoxy-based polymer matrix that includes an amine curing agent and a functionalized inorganic filler.

Other aspects and advantages of the claimed subject matter will be apparent from the following description and the appended claims.

### BRIEF DESCRIPTION OF DRAWINGS

FIG. 1 is a schematic depiction of a dendritic fibrous nanoparticle (DFN) in accordance with one or more embodiments of the present disclosure.

FIG. 2. is a block-flow diagram of a method of preparing functionalized inorganic fillers in accordance with one or more embodiments of the present disclosure.

FIG. 3 is a schematic depiction of a synthesis of functionalized inorganic fillers in accordance with one or more embodiments of the present disclosure.

FIG. 4 is a block-flow diagram of a method of preparing a polymer composite in accordance with one or more embodiments of the present disclosure.

FIG. 5 is a schematic depiction of a synthesis of an epoxy crosslinked network including functionalized inorganic filler in accordance with one or more embodiments of the present disclosure.

FIG. 6 is a transmission electron microscopy image of dendritic fibrous nanoparticles in accordance with one or more embodiments of the present disclosure.

### DETAILED DESCRIPTION

The present disclosure generally relates to functionalized inorganic fillers and the use thereof in polymer composites. The functionalized inorganic fillers may have a fibrous structure and a surface functionality. Polymer composites including such functionalized inorganic fillers may exhibit enhanced toughness and hardness while maintaining thermo-mechanical properties.

Functionalized Inorganic Filler Composition

In one aspect, embodiments disclosed herein relate to a functionalized inorganic filler composition. Functionalized inorganic fillers disclosed herein include an inorganic nanoparticle. Suitable inorganic nanoparticles include, but are not limited to, silica, titanium dioxide, zinc oxide, zirconium dioxide, and combinations thereof. In particular embodiments, the inorganic nanoparticle may be silica.

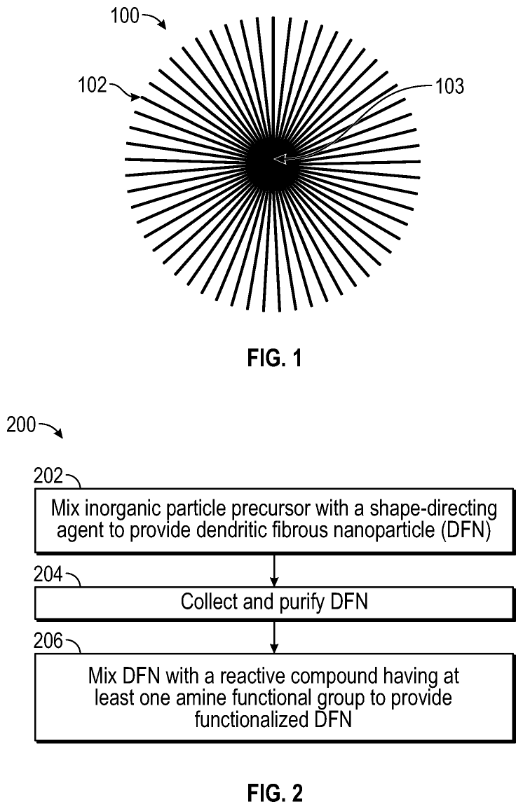

Inorganic nanoparticles disclosed herein may have a dendritic fibrous shape and a specific surface functionality. Such dendritic inorganic nanoparticles are referred to as dendritic functionalized nanoparticles (DFNs) herein. An exemplary structure of a DFN 100 is provided in FIG. 1. As shown in FIG. 1, DFN 100 may have a generally spherical shape with a plurality of dendritic fibers 102 on the surface of the nanoparticle such that the nanoparticle has an increased surface area and a large pore volume. The dendritic fibers 102 may be ordered and generally uniform extending out from a core 103 of the nanoparticle (i.e., they may be radially oriented). Such dendritic fibers 102 may be in the form of branches and/or wrinkles on the surface of the nanoparticle. DFNs may be characterized by the manner in which the dendritic fibers radiate out from the core in a flower-like or beaded formation, providing dendritic nanoparticles that have unique fibrous morphology, large radial pores, and dendritic pore networks. Such DFNs may have excellent thermal and hydrothermal stabilities, and high mechanical stability. The ordered dendritic fibers may be a result of the specific method of preparing the DFNs of the present disclosure.

In one or more embodiments, the functionalized inorganic filler includes a surface functionality linked to a surface of the DFNs. The surface functionality may include a reactive functional group that can act as a co-curing agent in a process for curing an epoxy resin. As such, the reactive functional group may be any suitable functional group that is capable of forming covalent linkages with an epoxy resin. In one or more embodiments, the reactive functional group may be an amine functional group. For example, the reactive functional group of the surface functionality may be a primary amine, a secondary amine, or a tertiary amine. In particular embodiments, the surface functionality may include a primary amine as the reactive functional group. The surface functionality may also include a “linker group” that links the surface functionality to the inorganic particle. The linker group may form a chemical bond with a surface-active group on the surface of an inorganic particle (e.g., a hydroxyl group on a silica nanoparticle). In particular embodiments, the linker group may be a silane linker group.

The surface functionality of one or more embodiments further includes a hydrocarbon group. The hydrocarbon group may connect the reactive functional group to the linker group. As used throughout this disclosure, the term “hydrocarbon group” refers to branched, straight chain, and/or ring-containing hydrocarbon groups, which may be saturated or unsaturated. The hydrocarbon groups may be primary, secondary, and/or tertiary hydrocarbons. In one or more embodiments, the hydrocarbon group may be a substituted hydrocarbon group where at least one hydrogen atom is replaced with a non-hydrogen group that results in a stable compound. Suitable substituents include, but are not limited to halo, hydroxyl, alkoxy, oxo, alkanoyl, aryloxy, alkanoyloxy, amino, alkylamino, arylamino, arylalkylamino, disubstituted amines, alkanylamino, aroylamino, aralkanoylamino, substituted alkanoylamino, substituted arylamino, aubstituted aralkanoylamino, thiol, alkylthio, arylthio, arylalkylthio, alkylthiono, arylthiono, aryalkylthiono, alkylsulfonyl, arylsulfonyl, arylalkylsulfonyl, sulfonamide, substituted sulfonamide, nitro, cyano, carboxyl, carbamyl, alkoxycarbonyl, aryl, substituted aryl, guanidine, vinyl, acetylene, acrylate, cyanate, epoxide, and heterocyclyl groups, and mixtures thereof. In embodiments in which the surface functionality includes an amine reactive group, a silane linker group, and a hydrocarbon group, suitable surface functionalities may be (3-aminopropyl)triethoxysilane, 4-amino-3,3-dimethylbutyltrimethoxysilane, n-(2-aminoethyl)-3-aminopropyltriethoxysilane, m-aminophenyltrimethoxysilane, 3-(m-aminophenoxy)propyltrimethoxysilane, and 4-amino-3,3-dimethylbutylmethyldimethoxysilane among others. In particular embodiments, the surface functionality linked to a DFN is (3-aminopropyl)triethoxysilane.

In one or more embodiments, functionalized inorganic fillers may have a size such that they may be added to and dispersed throughout an epoxy resin. Functionalized DFNs of the present disclosure may have an average diameter, measured by transmission electron microscopy (TEM) or dynamic light scattering (DLS), ranging from 100 to 500 nanometers (nm). For example, functionalized inorganic fillers may have an average diameter having a lower limit of any of 100, 125, 150, 175, 200, and 250 nm and an upper limit of any of 300, 350, 400, 425, 450, 475, and 500 nm where any lower limit may be paired with any mathematically compatible upper limit.

Method of Preparing a Functionalized Inorganic Filler

In another aspect, embodiments disclosed herein relate to a method of making a previously described functionalized inorganic filler. A block-flow diagram detailing methods of preparing functionalized DFNs is shown in, and discussed with reference to, FIG. 2. In FIG. 2, method 200 includes providing a solution of an inorganic particle precursor with a shape-directing agent 202. The shape-directing agent may induce the formation of branches and/or wrinkles in the inorganic particle. Suitable shape-directing agents include, but are not limited to, cetyltrimethylammonium bromide, tetrabutylammonium bromide, dodecytrimethylammonium bromide, cetyltrimethylammonium chloride, tetradecyltrimethylammonium bromide, cetylpyridinium bromide, and cetyltrimethylammonium tosylate. In one or more particular embodiments, the inorganic particle precursor is tetraethoxysilane (TEOS) or tetramethyl orthosilicate (TMOS). The solution may be stirred at ambient temperature for 0.5 to 3 hours and then heated to an elevated temperature for an amount of time. In particular embodiments, the solution may be placed in an autoclave and heated. The solution may be heated to an elevated temperature ranging from 85 to 200° C. for an amount of time ranging from 3 to 8 hours.

The solution may then be cooled to ambient temperature and the resultant dendritic fibrous nanoparticles may be collected and purified 204. DFNs may be collected using isolation techniques known to those with skill in the art, such as filtration, decantation, or centrifugation. In some embodiments, multiple rounds of isolation may be performed. The isolated DFNs may be further washed to remove any unreacted reagents. Suitable solvents used for washing isolated DFNs include purified water such as deionized water or distilled water, methanol, ethanol, isopropanol, propanol, isobutanol, hexanol and octanol, among others. The prepared DFNs may be dried overnight at room temperature, and subsequently calcined under continuous air flow at a temperature ranging from 450 to 650° C. for an about 2 to 6 hours to provide pure DFNs, so as to remove any residual reactants, reagents, and solvents.

Method 200 then includes mixing the pure DFNs with a reactive compound at an elevated temperature to provide the previously described functionalized inorganic particles 206. In particular embodiments, the DFNs and the reactive compound may be heated to reflux. The temperature of the reflux is dependent on the solvent used to mix the pure DFNs with the reactive compound. Suitable solvents include, but are not limited to, toluene, isooctane, benzene, heptane, cyclohexane, chlorobenzene, diglyme, and combinations thereof. The DFNs and reactive compound may be refluxed for an amount of time ranging from 12 to 48 hours, depending on the choice of DFNs and the reactive compound. For example, it may take an amount of time having a lower limit of any of 12, 18, 20, 24, 30, and 36 hours and an upper limit of any of 24, 30, 36, 42, and 48 hours where any lower limit may be paired with any mathematically compatible upper limit to form functionalized inorganic nanoparticle disclosed herein. After mixing at elevated temperature, the functionalized inorganic nanoparticles may be purified by washing with water. Any remaining reactive compound may be removed by drying the functionalized inorganic nanoparticles at an elevated temperature ranging from 80 to 160° C. for about 2 to 6 hours.

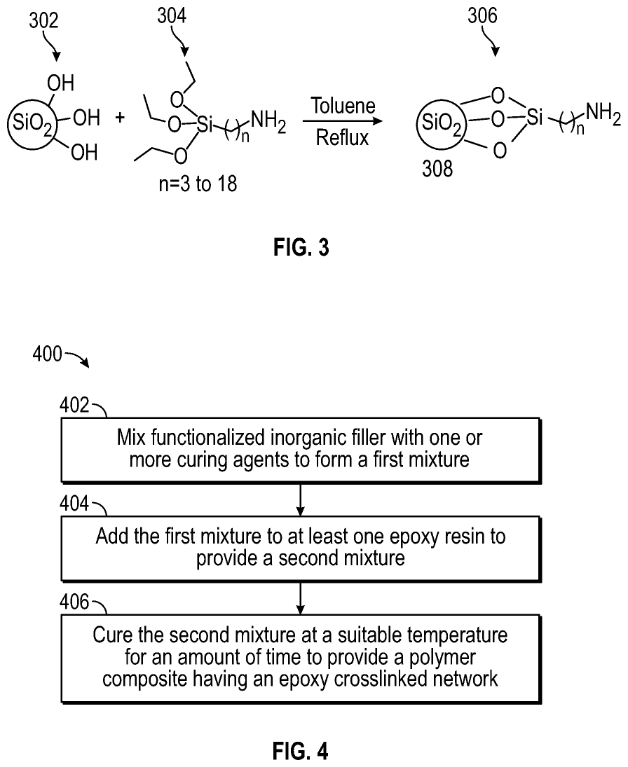

A reaction scheme in accordance with the previously described method of making functionalized inorganic fillers is shown in FIG. 3. Dendritic fibrous silica nanoparticles 302 having reactive hydroxyl groups on the surface may be reacted with a reactive compound ((3-aminopropyl)triethoxysilane) 304 having a silane group, an amine functional group, and a hydrocarbon group. In particular, dendritic silica nanoparticles 302 and (3-aminopropyl)triethoxysilane 304 may be heated to reflux in toluene for 24 hours to provide functionalized dendritic fibrous silica nanoparticles 306. Functionalized dendritic fibrous silica nanoparticles 308 may then isolated, washed, and dried using methods known to those skilled in the art.

Polymer Composite Composition

As described above, in one or more embodiments, functionalized inorganic fillers of the present disclosure may be included in an epoxy resin to form a polymer composite. Polymer composites including functionalized inorganic fillers disclosed herein may exhibit improved mechanical properties, such as hardness and impact resistance.

In one or more embodiments, polymer composite compositions include an epoxy-based resin, hereinafter also referred to as an epoxy resin. Any suitable epoxy resin may be used to form a polymer composite such as bisphenol-A-based epoxy resins, bisphenol-F-based epoxy resins, aliphatic epoxy resins, aromatic epoxy resins, Novalac resins, and combinations thereof. Aliphatic and aromatic epoxy resins may include glycidyl ethers and diglycidyl ethers. Glycidyl ethers may include alkyl glycidyl ethers, aromatic glycidyl ethers, or both. Glycidyl ethers have a chemical structure shown below in Formula (I):

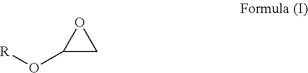

where R may be a linear, branched, cyclic, or aromatic hydrocarbon having from 4 to 24 carbon atoms. The hydrocarbon group may have a lower limit of one of 4, 6, 8, 10, and 12 carbon atoms, and an upper limit of one of 12, 14, 16, 18, 20, 22, and 24 carbon atoms, where any lower limit may be paired with any upper limit. In some embodiments, R may include one or more substituted or unsubstituted aromatic rings. In some embodiments, the epoxy resin may include C12-C14 alkyl glycidyl ethers, butyl glycidyl ether, 2,3-epoxypropyl-o-tolyl ether, or combinations of these.

In other embodiments, the epoxy resin may include diglycidyl ethers having a chemical structure shown below in Formula (II):

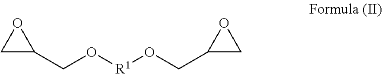

where R¹ may be a linear, branched, cyclic, or aromatic hydrocarbon having from 4 to 24 carbon atoms. The R¹ group may have a lower limit of one of 4, 6, 8, 10, and 12 carbon atoms, and an upper limit of one of 12, 14, 16, 18, 20, 22, and 24 carbon atoms, where any lower limit may be paired with any upper limit. In one or more embodiments, R¹ may include one or more substituted or unsubstituted aromatic rings. In one or more embodiments, R¹ may be an alkyl group or cycloalkyl group. For example, the epoxy resin may include 1,6-hexanediol diglycidyl ether, which has chemical structure as shown in Formula (III):

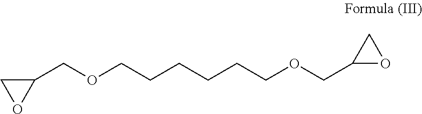 [SMILES: C(CCCOCC1CO1)CCOCC1CO1]

Non-limiting examples of the epoxy resin of one or more embodiments include diglycidyl ether of bisphenol A, diglycidyl ether of bisphenol F, epoxy phenol novolac resins, and combinations thereof. When in a crude, liquid form, such epoxy resins may exist in a monomeric form. In contrast, solid epoxy resins based on the listed compounds may have a high degree of polymerization. For example, the epoxy resin of bisphenol-A-diglycidyl ether (DGEBA) is shown below in Formula (IV). Liquid epoxies based on bisphenol-A-diglycidyl ether (DGEBA) may have an n of 0.2, whereas solid epoxies based on DGEBA may have an n of up to 35. In particular embodiments, the epoxy resin may be a DGEBA-based epoxy resin.

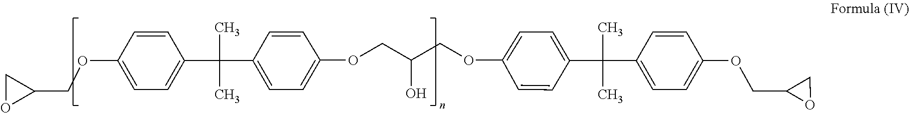

Polymer composites of the present disclosure may include an epoxy resin in an amount ranging from 70 to 98 wt. % (weight percent) based on the total weight of the polymer composite before curing. For example, the epoxy resin may be included in an amount having a lower limit of any of 70, 75, 80, and 85 wt. %, and an upper limit of any of, 85, 90, 95 and 98 wt. %, where any lower limit may be paired with any mathematically compatible upper limit.

In one or more embodiments, polymer composite compositions include a previously described functionalized inorganic filler. The functionalized inorganic filler includes a reactive group such that it may act as a co-curing agent in the process of curing the epoxy resin. Polymer composites may include a functionalized inorganic filler in an amount ranging from 0.1 to 20 wt. % based on the amount of epoxy resin. For example, the functionalized inorganic filler may be included in an embodiment polymer composite in an amount having a lower limit of any of 0.1, 0.25, 0.5, 1.0, 3.0, and 5.0 wt. % and an upper limit of one of 5.0, 8.0, 10, 12.5, 15, and 20 wt. %, where any lower limit may be paired with any mathematically compatible upper limit.

In one or more embodiments, polymer composite compositions further include a curing agent. As stated above, the functionalized inorganic filler may act as a co-curing agent in the curing of the epoxy resin. “Curing” refers to the process of crosslinking the epoxy resin, which is initially a liquid, with a curing agent to form a solid cured epoxy. The extent of such crosslinking may determine certain mechanical properties of the resultant epoxy, such as hardness. In embodiments including a curing agent, the curing agent may act in parallel with the functionalized inorganic filler to provide a cured epoxy with a high degree of crosslinking. The curing agent may be an amine curing agent. Suitable amine curing agents include, but are not limited to, polyetheramines, polyamides, amidoamines, ethyleneamines, cycloaliphatic amines, and aromatic amines. In particular embodiments, the amine curing agent may be isophorone diamine or 4,4′-methylenedianiline.

Polymer composite compositions may include the curing agent in an amount ranging from about 0.5 to 25 wt. % based on the total weight of the polymer composite before curing. For example, the curing agent may be included in an amount having a lower limit of any of 0.5, 1.0, 2.5, 5.0, 7.5, 10, and 12 wt. %, and an upper limit of any of 10, 12, 15, 18, 20, 22, and 25 wt. %, where any lower limit may be paired with any mathematically compatible upper limit.

Polymer composites of one or more embodiments may include at least one cured epoxy polymer network. The at least one cured epoxy polymer network may include a plurality of covalent linkages (or “cross-links”) of at least one functional group of the epoxy resin, the functionalized inorganic filler, the amine curing agent, and combinations thereof. Examples of the plurality of covalently linked functional groups may be derived from epoxide rings, amine groups, and combinations thereof.

As previously stated, epoxy resins including a functionalized inorganic filler of one or more embodiments may exhibit improved mechanical properties. For example, the inclusion of functionalized DFNs in an epoxy resin, may result in a polymer composite that has at least 5% greater hardness than an epoxy resin not including functionalized DFNs.

Method of Preparing a Polymer Composite

One or more embodiments of the present disclosure relate to a method of preparing polymer composites described above. The method may include adding a functionalized inorganic filler to an epoxy resin to form a resin mixture and curing the resin mixture. The resultant polymer composite may exhibit improved hardness compared to a cured epoxy resin not including the functionalized inorganic filler, as previously described.

A block-flow diagram of a method for making the polymer composites is shown in, and discussed with reference to, FIG. 4. Method 400 includes adding a functionalized inorganic filler to one or more amine curing agents to form a first mixture 402. The functionalized inorganic filler and one or more amine curing agents are as previously described. Then, the first mixture may be introduced into at least one epoxy resin to form a second mixture 404 and the second mixture may be cured at a suitable temperature for a period of time sufficient to form a polymer composite having an epoxy crosslinked network 406. The inorganic filler may be included in the epoxy crosslinked network such that the inorganic particles of the inorganic filler are homogeneously distributed throughout the crosslinked network. Accordingly, the resultant epoxy network does not include, or has limited aggregates of inorganic particles. Thus, a polymer composite with improved mechanical properties may be provided according to methods disclosed herein.

The polymer composite of one or more embodiments may have a curing time that enables the crosslinking of the epoxy resin with the curing agent and the functionalized inorganic filler, acting as a co-curing agent. For example, it may take an amount of time ranging from 0.5 to 48 hours to cure the epoxy resin at ambient temperature. In some embodiments, the curing step may include heating the second mixture for a period of time. For example, the second mixture may be heated to 60 to 80° C. for an additional 12 hours to promote curing.

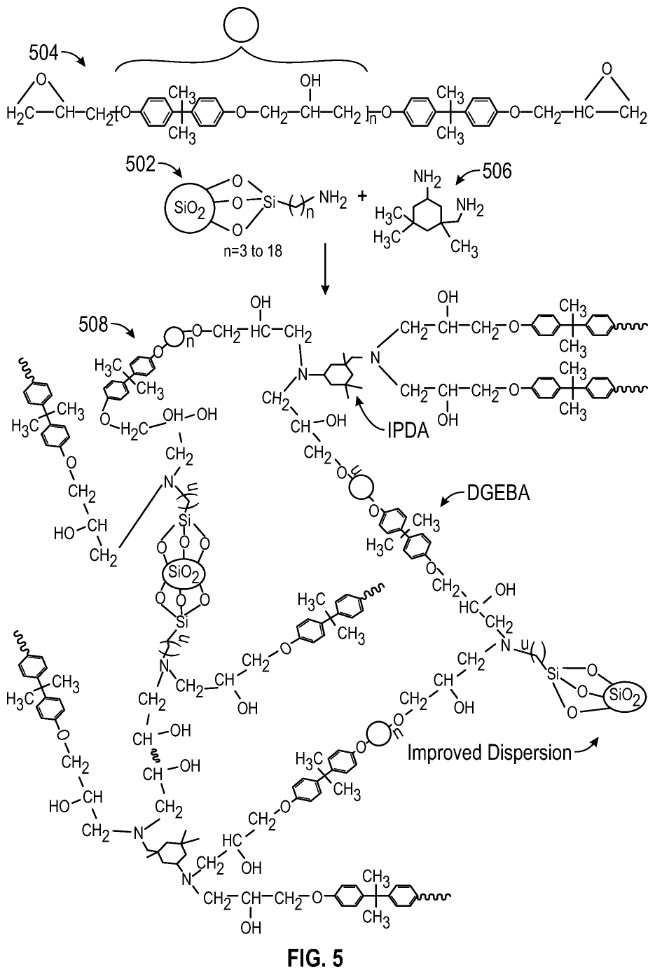

A schematic depiction of method 400 is shown in FIG. 5. Amine-functionalized dendritic silica nanoparticles 502, diglycidyl ether of bisphenol A (DGEBA) 504, and isophorone diamine (IPDA) 506 are combined and cured to provide epoxy crosslinked network 508. The improved dispersity of silica nanoparticles is demonstrated in epoxy crosslinked network 508. Due to the crosslinking of the functionalized silica particles with the epoxy network, aggregation of silica particles may be minimized in polymer composites prepared in accordance with the present disclosure.

### EXAMPLES

(3-aminopropyl)triethoxysilane, tetraethoxy silane, cetyltrimethylammonium bromide, urea, cyclohexane, toluene, and ethanol were supplied by Sigma-Aldrich. Deionized water was prepared in-house using a deionized water system. DGEBA and IPDA were provided by Jubail Chemical Industries Company (JANA).

### Example 1—Functionalized Inorganic Filler

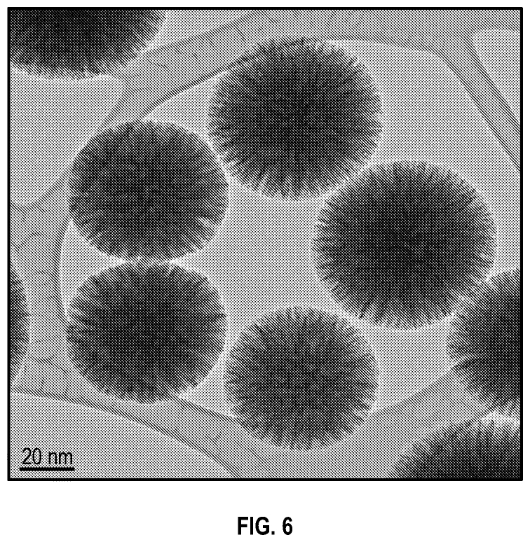

Dendritic fibrous silica particles were prepared by the following hydrothermal process. A solution composed of tetraethoxysilane (20 g), cyclohexane (240 mL) and 1-pentanol (12 mL) was prepared and stirred for 30 minutes (min). Concurrently, an additional solution including cetyltrimethylammonium bromide (8 g), urea (4.8 g), and deionized water (240 mL) was mixed and stirred for 30 minutes. The tetraethoxysilane solution was then added into the cetyltrimethylammonium bromide solution and stirred for 1 hours (h). The solution was then transferred into an autoclave and heated in an oven at 125° C. for 4 to 6 h. The autoclave was then gradually cooled, and the silica particles were collected by repeated centrifugation in deionized water and ethanol. After being dried overnight at room temperature, the synthesized powder was calcined under continuous air flow at 550° C. for 4 h yielding the dendritic fibrous silica particles as a pure white powder. FIG. 6 shows an image of the resultant DFNs under transmission electron microscopy (TEM).

Then, 10 g of the dendritic fibrous silica particles were dispersed in dry toluene and stirred for 30 min at room temperature. Subsequently, 30 ml of (3-aminopropyl)triethoxysilane was added dropwise and the resulting mixture was refluxed for 24 hours. The resultant solution was then cooled to room temperature. Once at ambient temperature, the functionalized dendritic fibrous silica particles were collected by centrifugation and washed three times with toluene and two times with ethanol in order to remove unreacted 3-aminopropyltriethoxysilane. The obtained amino-functionalized dendritic fibrous silica particles were dried at 120° C. for 4 h.

### Example 2—Polymer Composite

To prepare a polymer composite including the above amino-functionalized dendritic fibrous silica particles, 0.811 g of the functionalized silica particles were dispersed in 4.82 g of isophorone diamine (IPDA). Subsequently, the mixture of functionalized silica particles and IPDA was mixed into 21.87 g of diglycidyl ether of bisphenol A (DGEBA) to provide a homogenous mixture of DGEBA/IPDA including 3 wt. % functionalized silica particles. The homogenous mixture was then degassed under vacuum at room temperature, poured into a silicone mold, and left to cure for 24 hours at room temperature. After curing, the mixture was then post-cured at a 80° C. for 4-5 hours. A similar procedure was followed for the preparation of neat DGEBA/IPDA to prepare a comparative sample that does not include DFNs. Results of hardness tests that were conducted in compliance with ASTM D-2240 using a Shore D durometer are shown in Table 1, below.

TABLE 1
Hardness of DGEBA Samples

| Samples | Shore D Hardness |
|---|---|
| DGEBA/IPDA | 78.1 |
| DGEBA/IPDA (3 wt. % silica) | 83.06 |

As shown, the polymer composite including the DFNs in accordance with the present disclosure demonstrated a higher hardness than an epoxy resin without the silica particles.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A functionalized inorganic filler comprising:
a dendritic fibrous nanoparticle comprising a surface functionality comprising at least one amine functional group linked to a surface of the dendritic fibrous nanoparticle.

2. The functionalized inorganic filler of claim 1, wherein the amine functional group is a primary amine.

3. The functionalized inorganic filler of claim 1, wherein the surface functionality is selected from the group consisting of (3-aminopropyl)triethoxysilane, 4-amino-3,3-dimethylbutyltrimethoxysilane, n-(2-aminoethyl)-3-aminopropyltriethoxysilane, m-aminophenyltrimethoxysilane, 3-(m-aminophenoxy)propyltrimethoxysilane, 4-amino-3,3-dimethylbutylmethyldimethoxysilane, and combinations thereof.

4. The functionalized inorganic filler of claim 1, wherein the dendritic fibrous nanoparticle is selected from the group consisting of a silica particle, a titanium dioxide particle, a zinc oxide particle, a zirconium dioxide particle, and combinations thereof.

5. The functionalized inorganic filler of claim 4, wherein the dendritic fibrous nanoparticle is a silica particle.

6. The functionalized inorganic filler of claim 1, wherein the functionalized organic filler has a diameter ranging from 100 to 500 nm.

7. A method of making a functionalized inorganic filler, the method comprising:
reacting an inorganic particle precursor and a shape-directing agent to provide a dendritic fibrous nanoparticle; and
reacting the dendritic fibrous nanoparticle with a reactive compound comprising at least one amine functional group to form the functionalized inorganic filler.

8. The method of claim 7, wherein the inorganic particle precursor is tetraethoxysilane.

9. The method of claim 7, wherein the shape-directing agent is selected from the group consisting of cetyltrimethylammonium bromide, tetrabutylammonium bromide, dodecytrimethylammonium bromide, cetyltrimethylammonium chloride, tetradecyltrimethylammonium bromide, cetylpyridinium bromide, cetyltrimethylammonium tosylate, and combinations thereof.

10. The method of claim 7, wherein the reactive compound is selected from the group consisting of (3-aminopropyl)triethoxysilane, 4-amino-3,3-dimethylbutyltrimethoxysilane, n-(2-aminoethyl)-3-aminopropyltriethoxysilane, m-aminophenyltrimethoxysilane, 3-(m-aminophenoxy)propyltrimethoxysilane, 4-amino-3,3-dimethylbutylmethyldimethoxysilane, and combinations thereof.

11. The method of claim 7, wherein the inorganic particles are selected from the group consisting of silica particles, titanium dioxide particles, zinc oxide particles, zirconium dioxide particles, and combinations thereof.

12. A polymer composite comprising:
an epoxy-based polymer matrix, wherein the epoxy-based polymer matrix comprises an amine curing agent; and
a functionalized inorganic filler.

13. The polymer composite of claim 12, wherein the epoxy-based polymer matrix is selected from the group consisting of diglycidyl ether of bisphenol A, diglycidyl ether of bisphenol F, an epoxy phenol novolac resin, and combinations thereof.

14. The polymer composite of claim 12, wherein the functionalized inorganic filler is present in an amount ranging from 0.1 to 30 wt. % (weight percent) based on an amount of the epoxy-based polymer matrix.

15. The polymer composite of claim 12, wherein the polymer composite has a Shore D hardness at least 5% greater than the Shore D hardness of the epoxy-based polymer matrix.

16. A method of making the polymer composite of claim 12 the method comprising:
mixing a functionalized inorganic filler with one or more amine curing agents to form a first mixture, wherein the functionalized inorganic filler comprises dendritic fibrous nanoparticles comprising a surface functionality comprising at least one amine functional group linked to a surface of the dendritic fibrous nanoparticles;
introducing the first mixture into one or more epoxy resins to form a second mixture; and
curing the second mixture to form an epoxy crosslinked network, wherein the functionalized inorganic particle is dispersed uniformly throughout the epoxy crosslinked network.

17. The method of claim 16, wherein the amine curing agent is selected from the group consisting of triethylenetetramine, diethylenetriamine, m-phenylenediamine, methylenedianiline, isophorone diamine, 4,4′-methylenedianiline, and combinations thereof.
